(19) United States
(12) Patent Application Publication
(10) Pub. No.: US 2026/0326109 A1
(43) Pub. Date: Oct. 22, 2026

(54) CUVETTE FOR PROCESSING A SAMPLE

(71) Applicant: HOMBRECHTIKON SYSTEMS ENGINEERING AG, Hombrechtikon (CH)

(72) Inventors: Konstantin LUTZE, Uerikon (CH); Deniel ZWIRNER, Zurich (CH)

(21) Appl. No.: 19/649,434

(22) Filed: Apr. 16, 2026

(30) Foreign Application Priority Data
Apr. 17, 2025 (EP) 25171332.7

(51) Int. Cl. B01L 3/00

(52) U.S. Cl. CPC B01L 3/5088; B01L 2300/0838; B01L 2400/0406

(57) ABSTRACT

A cuvette includes a cuvette body with a proximal end, a distal end and a cuvette chamber, the cuvette to be arranged with the proximal end on a pipette tip and the sample to be received via the distal end, and a receiving element to receive the sample attached to the distal end, and the receiving element including a capillary element arranged on the receiving element such that the sample is capable of being received into the capillary element by capillary forces, and a first fluid is capable of being introduced into the cuvette chamber, the receiving element attached to a wall of the cuvette body surrounding the cuvette chamber such that the first fluid is capable of being brought into contact with the sample located in the capillary element, and the sample is capable of being received into the cuvette chamber by adhesion forces.

### CROSS-REFERENCE TO RELATED APPLICATIONS

This application claims priority under 35 U.S.C. §119(a) to European Patent Application No. 25171332.7, filed on Apr. 17, 2025. The entire contents of European Patent Application No. 25171332.7 is hereby incorporated herein by reference.

### TECHNICAL FIELD

The disclosure relates to a cuvette for processing a fluid sample, a pipetting device for processing a fluid sample and a method for processing a fluid sample.

### BACKGROUND

When processing a large number of samples, a large number of processing steps have to be carried out. For this purpose, laboratory automatic machines are generally used, since precise pipetting of reagents into and out of containers, such as microwell plates, has to be ensured.

The laboratory automatic machines of the state of the art here generally comprise a treatment chamber, into which the samples are introduced into containers; a pipetting device for carrying out the processing steps; a movement device for moving the pipetting device in the treatment chamber and an electronic control device, which controls and instructs the pipetting device and other parts of the laboratory automatic machine for carrying out the processing steps.

The laboratory automatic machines therefore ensure an automated sample preparation process with increased efficiency and improved throughput.

### SUMMARY

It has been determiend however, that pipetting devices are used not only in laboratory automatic machines, but generally for metering liquids. These liquids are received and dispensed into a pipette tip of the pipetting device through a tip opening. For this purpose, a displacement element is integrated into the pipetting device, in particular a displacement element for a gas, which is connected in terms of flow to the pipette tip by a docking element for the pipette tip. An air cushion is displaced by the displacement element, so that liquid is sucked into the pipette tip and ejected therefrom. The displacement element is generally a cylinder with a piston displaceable therein.

The pipette tips are detachably connected to the docking element, so that they can be exchanged for a fresh pipette tip after use. As a result, contamination can be avoided during subsequent metering. Pipette tips for single use are inexpensively available from plastic.

The docking element comprises in particular a projection for fastening pipette tips of preferably cylindrical or conical shape, onto which the pipette tip can be clamped with a fitting plug-on opening or receptacle. This can be done without gripping the pipette tip by pressing the projection into the plug-on opening of the pipette tip standing ready in a holder.

To avoid contamination, pipetting devices preferably have an ejection device with a drive device and an ejector. By actuating the drive device, the ejector is displaced such that it releases the pipette tip from the projection without the latter having to be touched by the user. For this purpose, the drive device generally has a mechanism which can be actuated manually by a button (or also automatically in the case of a laboratory automatic machine) in order to release the pipette tip from the docking element.

In the state of the art, it is also customary to arrange cuvettes on the pipette tips in order to dispense a fluid into the cuvette and to analyze it in the cuvette. The cuvette is arranged on the pipette tip in this case, analogously to the fastening of the pipette tip on the cuvette, preferably without the user having to touch the cuvette.

In the case of a laboratory automatic machine, a displacement element of the pipetting device can be integrated into the docking element, in particular arranged in the interior of the docking element. Here, the displacement element can be configured as a piston displaceable in the docking element.

The laboratory automatic machines often also have integrated optical detection devices for analyzing the samples and/or mixtures of samples and introduced fluids. The analysis is generally carried out using optical techniques such as spectroscopy or photometry.

In particular in the case of biomolecules, luminescence spectroscopy is an important analysis method in which the emission light which arises on the basis of a photon absorption of the biomolecules is evaluated.

For this purpose, fluorescent chemical groups which then serve as markers for this biomolecule can be attached to large biomolecules by a fluorescent label.

In many processes, in particular the concentration of the sample (that is to say of the relevant molecules in solution) plays a role for further processing, which is easy to determine, in particular by fluorescence spectroscopy.

In the context of this disclosure, the term "sample" can be understood to mean, in particular, a sample which comprises a liquid with substances such as biomolecules (inter alia DNA, RNA, nucleic acids, proteins, cells and cell constituents, monomers) or other chemical substances. In the context of the disclosure, a fluid can be, for example, a suitable solvent.

The optical density (measure for the attenuation of radiation after passing through a medium) can also be used for determining the concentration.

Laboratory automatic machines and, in particular, pipetting devices can be used for receiving different amounts of fluid. However, precisely for receiving small amounts of fluid or small sample volumes, in the order of up to 1.5 μl, they are often inaccurate and difficult to handle, since the small volume, solely as a result of the influence of phenomena such as surface tension and adhesion, tends to adhere to containers and walls of pipette tips and cuvettes. Thus, pipetting operations at these volumes often have a CV value of 10% and more.

The disclosure is directed to this problem. It is therefore an aim of the disclosure to provide a cuvette which eliminates these disadvantages from the state of the art.

The subject matter of the disclosure which meets this purpose is characterized by the features disclosed herein.

Further advantageous measures and embodiments emerge from the spresent disclosure.

According to the disclosure, a cuvette for processing a sample is proposed which comprises a cuvette body with a proximal end, a distal end and a cuvette chamber forming the interior space of the cuvette body.

The cuvette can in this case be arrangeable with the proximal end on a pipette tip and the sample can be received via the distal end.

For this purpose, a receiving element for receiving the sample can be attached to the distal end. This receiving element comprises at least one capillary element, wherein the capillary element is arranged on the receiving element in such a way that the sample can be received into the capillary element by capillary forces of the capillary element. The capillary element allows volume to be received in a very targeted manner. This is advantageous in particular in the case of small sample volumes of less than 1.5 μl, since, as already mentioned above, the handling of these sample sizes involves difficulties.

A first fluid can be introduced into the cuvette chamber and the receiving element can be attached to a wall of the cuvette body surrounding the cuvette chamber in such a way that the first fluid can be brought into contact with the sample located in the capillary element and the sample can be received into the cuvette chamber by adhesion forces of the first fluid.

The capillary element can have different shapes and be configured differently. Thus, for example, it can be a capillary channel. However, it is also conceivable for two plates arranged in parallel to be used, so-called capillary plates, between which capillary forces occur along their mutually facing plate surfaces. The use and arrangement of more than two capillary plates is also conceivable.

The arrangement of at least one capillary channel also includes the arrangement of a plurality of channels, with the result that, for example, the reception of a plurality of different samples or fluids is made possible as a result. This has advantages in particular in the analysis of a sample but also in the observation and analysis of a reaction with a plurality of educts. In this way, a plurality of analysis steps and substances can be carried out or supplied in a targeted manner and with observation.

The same advantage can of course also occur in the use of a plurality of capillary plates.

A further advantage of the low volume uptake by the capillary element, in particular the capillary channel, is that fewer sample volumes have to be produced or provided from the beginning in order to be able to analyze the sample or a reaction. This is a decisive cost advantage since this also means that less volume of the other educts is required in order to be able to analyze the sample in the same time.

In addition, fewer personnel are required who produce the large volumes of the samples.

In one exemplary embodiment of the cuvette, the receiving element can be arrangeable as an extension of at least the wall of the distal end of the cuvette.

As a result, it is also possible to equip normal, that is to say commercially available, cuvettes with the receiving element and to use them for receiving small, exact sample volumes.

In a further exemplary embodiment, the cuvette can comprise at least one measuring surface arranged on the cuvette body. In this case, the measuring surface can be attached in particular to a circumferential side of the cuvette body. This measuring surface enables an accurate analysis of the contents of the cuvette. In this way, a sample or a fluid in the interior of the cuvette, that is to say of the cuvette chamber, can be analyzed at a specific time or during a specific time window. In particular, a detection device with which the analysis can be carried out can be arranged on the measuring surface. In this case, the detection device can be operated manually.

A fully automated detection device is likewise conceivable, as is a remotely controllable detection device.

In an embodiment of the disclosure, the detection device can comprise a radiation source for irradiating the sample and/or the mixture of sample and fluid with a primary radiation and a detector for receiving a secondary radiation originating from the sample and/or the mixture (for the analysis thereof). The radiation source therefore generates an electromagnetic radiation (the primary radiation). The secondary radiation is in particular an electromagnetic secondary radiation emitted/originating from the sample and/or the mixture, which secondary radiation is induced by an interaction of the primary radiation with the sample and/or the mixture.

Here, UV/Vis radiation and/or NIR radiation, in particular in the wavelength range of 190-1000 nm, in particular 365-720 nm, is particularly preferably used as primary radiation. Here, a diode, in particular a silicon photodiode or a vacuum photodiode, is in particular suitable as detector. A laser, a deuterium lamp, a tungsten lamp, a halogen lamp, a mercury-vapor lamp or an LED (light-emitting diode) can be used as radiation sources.

In practice, the detection device can also comprise a large number of detectors and/or radiation sources. Here, the radiation sources can emit different wavelengths or wavelength ranges as primary radiation. Here, the use of two radiation sources, which are configured as a first radiation source (preferably first LED) with a first wavelength (e.g. 450-490 nm) and a second radiation source (preferably second LED) with a second wavelength (e.g. 600-630 nm), is particularly preferable. If a large number of radiation sources are present, the analysis can be carried out confocally. The beam paths of the primary radiation from the different radiation sources are therefore directed to a common focal point in the sample and/or the mixture.

The detection device can therefore be a photometer, in particular a spectrometer, in particular a fluorometer. The fluorometer measures the parameters of the fluorescence of the sample and/or of the mixture: intensity and wavelength distribution of the emission spectrum (of the secondary radiation) after excitation by the primary radiation.

In the context of the disclosure, an absorption measurement can be used as measurement principle, wherein the radiation source generates primary radiation in the UV/Vis range and/or NIR range (in particular of a single wavelength, such as e.g. 280 nm) and the light beam (secondary radiation) attenuated by the passage through the sample and the extension is detected by the detector. Here, the extinction or optical density (measure for the attenuation of the primary radiation in a medium (sample and extension) is preferably used for characterizing the absorption intensity.

Furthermore, a camera is preferably used in the context of the disclosure in order to measure and analyze the sample. Here, the camera can operate in all customary wavelength ranges, for example in the visible light, in the UV range and infrared range.

In a further exemplary embodiment of a cuvette according to the disclosure, the cuvette can have a tapering at the distal end, with the result that a circumference of an arrangement of cuvette and receiving element is substantially equal to the circumference of the cuvette at the proximal end.

This is advantageous, for example, during the handling of the cuvette, in particular during transport, since a combination of cuvette and at least one receiving element can thus be carried out using the same tool on each circumferential side of the combination without the gripping tool having to be readjusted to the circumference at the respective point of the combination.

In a further exemplary embodiment of a cuvette according to the disclosure, the cuvette can have, at the distal end, a first connecting region which can be connected to the receiving element by a second connecting region at the proximal end of the receiving element, with the result that the receiving element can be arranged in a removable manner on the cuvette by the connecting regions. Here, the first and the second connecting region can form in particular a form-fitting and/or force-fitting, fluid-tight plug connection. This has the advantage that the fluid flow between the cuvette and the receiving element can be produced reversibly by the connection.

The form-fitting plug connection can have, for example, depressions in the first connecting region and matching elevations on the second connecting region, in order to increase the resistance of the plug connection to external forces.

In a further exemplary embodiment of a cuvette according to the disclosure, the capillary channel can have a first section for receiving the sample and a second section for dispensing the sample, wherein the sections are preferably openings. Here, the first section can be arranged in particular on the distal end of the receiving element, with the result that the channel is open at the end with the first section, that is to say has no end wall there which delimits the capillary channel in the longitudinal direction.

It is also conceivable for the capillary channel to be a capillary channel which is open on a circumferential side, with the result that an open circumferential side is present.

Furthermore, it is conceivable for the first and the second section to be arranged together on one of the circumferential sides, wherein the second section is arranged between the first section and the proximal end of the cuvette. The arrangement of the first and of the second section in each case on different circumferential sides of the capillary channel is also conceivable.

It is likewise conceivable for the channel to have in each case one end wall at both ends, with the result that it is delimited in the longitudinal direction by the end walls.

Preferably, at least the second section can be arranged on the open circumferential side.

Likewise, the first and the second section can be arranged one behind the other in the longitudinal direction on a circumferential side in such a way that they form the open circumferential side.

Such a capillary channel has advantages in particular in the production, since this can be produced more easily in customary methods, such as, for instance, injection molding, than a channel with four or more closed circumferential sides.

During the production of high quantities, a scaling effect with regard to material and weight savings also comes into play.

In a further exemplary embodiment of a cuvette according to the disclosure, the capillary element, in particular the capillary channel, can extend on an inner side of the receiving element from a distal end of the receiving element via the proximal end of the receiving element and on an inner wall of the cuvette chamber adjoining the proximal end into the cuvette chamber.

In general, it is conceivable for more than one capillary element, in particular more than one capillary channel, to extend on the inner side as described above. In this way, for example, a plurality of samples can be received simultaneously. The reception of substances for the analysis of the samples is also conceivable, with the result that these substances can be received into the cuvette chamber simultaneously with the sample. This allows, inter alia, a temporal start of a reaction in the cuvette chamber which can be controlled in a targeted manner or an analysis of the contents of the cuvette chamber.

Here, the substances for the analysis can be analysis substances known to the person skilled in the art, for example dyes, luminescent or radioactive markers or else biomolecules such as, for instance, enzymes.

In a preferred exemplary embodiment of a cuvette according to the disclosure, the capillary element, in particular the capillary channel, can extend only as far as the cuvette chamber.

This has the advantage that no part of the capillary element, in particular no part of the capillary channel, has to be present in the cuvette, which simplifies the production of the cuvette, for example in the injection molding method. In addition, it also enables the use of commercially available cuvettes which have no capillary element.

Of course, a cuvette according to the disclosure can also be produced from other materials, for instance glass or else from combinations of different materials.

In a preferred exemplary embodiment of the cuvette according to the disclosure, the receiving element can be attached to the distal end of the cuvette in such a way that it extends over 5 - 80% of the area of the distal end, preferably over 15 - 80% and further preferably over 20 - 40% and particularly preferably over 20 - 33% of the area.

As a result of the different area coverage by the receiving element, the position of the mouth region of the capillary element, in particular of the capillary channel, at the distal end of the cuvette can be adapted. This has the advantage that sample, fluid, dyes, analysis substances or other substances can be introduced into the cuvette at predefinable points, which can be used for an advantageous distribution of the same in the cuvette.

The receiving element can also consist, for example, of two mutually opposite plates, wherein the plates each have a first and a second surface and both plates can be arranged next to one another in such a way that the first and second surfaces of the plates are arranged parallel to one another and that a capillary force can build up between two mutually opposite surfaces of the plates. As a result of this capillary force, a sample/a fluid can be received and transported between the plates.

In a further exemplary embodiment of the cuvette according to the disclosure, the receiving element can be an integral component of the cuvette.

As a result, the holding of the receiving element on the cuvette can be improved. In addition, the processing step of arranging the receiving element on the cuvette is thus omitted.

In a further exemplary embodiment of the cuvette according to the disclosure, a volume which can be received by the capillary element, in particular the capillary channel, can be predefined by a geometry of the capillary element, with the result that an accurately predefinable volume can always be received by the capillary element, wherein the capillary element can have, in particular, a defined inner contour with a predetermined cross section and/or a corresponding length, with the result that the volume which can be received can be unambiguously defined by these geometric parameters.

Different possibilities are conceivable for the shape of the capillary channel. Thus, the channel can be round or oval, or else have a polygonal average area. However, the cuvette channel preferably has a rectangular shape.

Here, the capillary channel is preferably between 0.3 and 0.6 mm deep, 0.5-0.9 mm wide and 6.3-6.7 mm long, particularly preferably 0.4 mm deep, 0.7 mm wide and 6.5 mm long.

In a preferred exemplary embodiment of the cuvette according to the disclosure, a dye, preferably a dried dye, which can be attached to the walls of the cuvette, can be introduced into the cuvette. It is likewise conceivable for the dye to be able to be introduced into the capillary element. This has the advantage that no dye has to be received into the cuvette in an additional processing step. In addition, in this way, the amount of dye can be ensured exactly and consistently, which is advantageous precisely in the analysis of a plurality of samples, since the variance in the measurement results is thus reduced.

In a preferred exemplary embodiment of the cuvette according to the disclosure, the capillary element can be conditioned, for instance by plasma treatments known to a person skilled in the art and/or surface coatings such as, for example, PEG coatings.

In this way, the channel can be coated, for example, with a hydrophilic coating, which enables improved transport of fluids and substances in the capillary element. This effect can also be brought about by another of the abovementioned conditioning methods.

The conditioning or coating of the cuvette chamber and/or of the entire cuvette with one or more of these methods and substances is also conceivable.

In a preferred exemplary embodiment of the cuvette according to the disclosure, the cuvette can be electrically conductive. In particular, it can be electrically conductive between the receiving element and the proximal end of the cuvette body. This can be achieved by the cuvette being produced at least partially from an electrically conductive material and/or being coated at least partially with an electrically conductive layer. This layer can be applied by vapor deposition, for example.

This has the advantage that so-called "capacitive liquid level detection" can be used in order to detect the immersion of the cuvette into the sample.

In addition, a method according to the disclosure for processing a sample with a cuvette is proposed, comprising the following steps:
providing a pipetting device, arranging the cuvette on the pipetting device and introducing a first fluid into the cuvette by the pipetting device. Receiving the sample into the capillary element of the receiving element by introducing the receiving element into the sample and receiving the sample into the cuvette chamber from the capillary channel via adhesion by establishing a contact between the first fluid and the sample by actuation of the pipetting device

This enables the reception of an exact amount of volume of a sample, of an analysis substance or of a fluid, precisely also of volumes of less than 2 μl. In particular, the reception of volumes of less than 1.5 μl is possible, and of volumes of less than 1 μl and even of less than 0.5 μl is envisaged.

In addition, the volume to be received can be received into the capillary element in less than one second by the use of capillary forces. This is an advantage in particular when reactions are analyzed, since it is important for this purpose to know when two substances come into contact with one another and how high the degree of mixing of the two substances is from the beginning, which can be found out in this way.

In a method according to the disclosure, the fluid and/or the sample can be mixed by pipetting on and off in the cuvette and/or in the pipette tip.

This brings about the advantage that an extra mixing vessel is not necessary. Therefore, a saving of resources can be brought about in this way. In addition, the separate reception of sample and fluid ensures that both substances are received safely and without contamination, and resources and time are saved at the same time.

In a method according to the disclosure, the sample and/or a mixture of fluid and sample can be dispensed from the cuvette.

It is precisely during the processing of potentially hazardous substances that the risk of contact with these substances can thus be reduced. Residues of large volumes of fluid, mixture or sample in used cuvettes or pipette tip can thus be reduced and can thus no longer constitute a risk to persons.

In addition, liquid and solid laboratory waste can be separated cleanly in this way and recycled better, since the fluid residues are dispensed from the cuvette.

In a method according to the disclosure, the sample and/or the fluid and/or the mixture of sample and fluid can be analyzed, in particular they can be analyzed by a detection device. In this case, they can preferably already be analyzed in the cuvette chamber. However, a preceding or subsequent analysis outside the cuvette chamber is likewise conceivable. In this way, a continuous, gapless analysis of the sample/of the fluid/of the mixture can be ensured.

In addition, it enables a broad and flexible use of different analysis devices in the detection device in order to achieve the best possible results in each case. The use of a plurality of analysis devices at the same time is also conceivable. Here, it is possible both for different types of analysis and for analyses of the same type or a combination thereof to be involved.

### BRIED DESCRIPTION OF THE DRAWINGS

The disclosure is explained in more detail below with reference to exemplary embodiments and the drawings. The schematic drawings show, partially in section:

FIG. 1 is a schematic illustration of a cuvette according to the disclosure with a receiving element;

FIG. 2 is a schematic illustration of a detail of a cuvette according to the disclosure with a receiving element;

FIG. 3 is a schematic illustration of a cuvette according to the disclosure arranged on a pipetting device;

FIG. 4 is a schematic illustration of a cuvette according to the disclosure in cross section;

FIG. 5 is a schematic illustration of a cuvette according to the disclosure with capillary plates;

FIG. 6 is a schematic illustration of a laboratory automatic machine with a cuvette according to the disclosure;

FIG. 7 is a schematic illustration of a pipetting device with a cuvette according to the disclosure and the directions of movement of the pipetting device in a laboratory automatic machine.

It should be understood that the drawings are schematic and schematic illustrations of exemplary embodiments of the disclosure and neither restrict the present disclosure nor are necessarily drawn to scale.

### DETAILED DESCRIPTION

The novel features which are characteristic of the disclosure, both in terms of their construction and their mode of operation, together with further aims and advantages, will become apparent from the following description, which is considered in conjunction with the accompanying drawings in which an embodiment of the disclosure is illustrated by way of example.

In the following description, the different embodiments of the present disclosure are described with reference to the accompanying drawings. As required, detailed embodiments of the present disclosure are discussed here; however, it is to be understood that the disclosed embodiments are merely exemplary of the embodiments of the disclosure which can be embodied in different and alternative forms. The figures are not necessarily true to scale, and some features may be exaggerated or minimized in order to show details of particular components. Therefore, specific structural and functional details disclosed here are not to be interpreted as limiting, but merely as a representative basis for showing the person skilled in the art how he can apply the present disclosure in different ways.

The singular forms “a”, “an” and “the” used here include the plural, unless the context clearly dictates otherwise. The reference to “a pulverulent material” also means, for example, that mixtures of one or more pulverulent materials may be present, unless this is expressly excluded.

Unless stated otherwise, all numbers used in the specification and claims which express amounts are to be understood as being modified by the term “approximately” in all examples. Accordingly, the numerical parameters given in the specification and claims are, unless stated otherwise, approximate values which can vary depending on the desired properties to be achieved by the embodiments of the present disclosure. At the very least, each numerical parameter should be interpreted taking into account the number of significant digits and the customary rounding conventions, without this being regarded as an attempt to limit the application of the teaching from the equivalents to the scope of the claims.

Furthermore, the indication of numerical ranges in this specification is considered to disclose all numerical values and ranges within that range (unless expressly stated otherwise). If, for example, a range ranges from about 1 to about 50, it is assumed that it comprises e.g. 1, 7, 34, 46.1, 23.7 or any other value or range within the range.

The terms “about” and “approximately” indicate that the amount or value concerned can be the specified specific value or some other value in its vicinity. In general, the terms “approximately” and “approximately” which denote a specific value are intended to denote a range within ± 5% of the value. One example: the phrase “about 100” denotes a range of 100 ± 5, i.e. the range of 95 to 105. If the terms “about” and “approximately” are used, it can generally be assumed that similar results or effects according to the disclosure can be achieved within a range of ±5% of the specified value.

The term “and/or” used here means that either all or only one of the elements of the specified group can be present. For example, “A and/or B” means “only A or only B or both A and B”. In the case of “only A”, the term also covers the possibility that B is not present, i.e. “only A but not B”.

The term “substantially” is used to denote that the following feature, the following property or the following parameter is either completely (completely) realized or fulfilled or to an extent which does not impair the intended result.

The term “containing” used here is not to be understood as being exclusive and open-ended. However, the term “comprising” also comprises the more restrictive meanings “substantially consisting of” and “consisting of”, with the result that, for example, “a composition which comprises a compound A” can also consist (substantially) of the compound A.

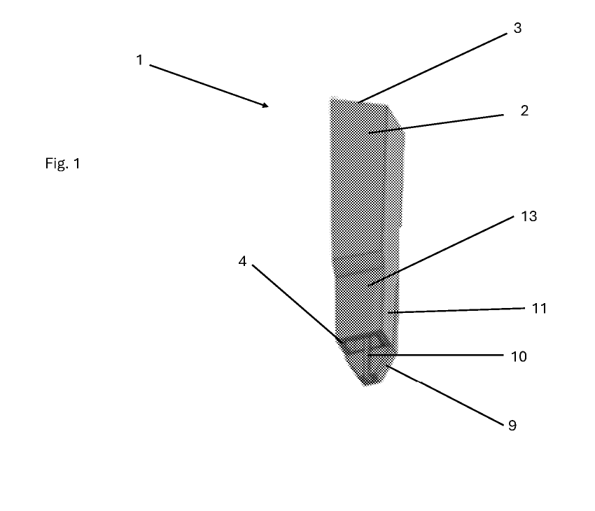

FIG. 1 shows a schematic illustration of a cuvette according to the disclosure for processing a sample 8 (not illustrated), comprising a cuvette body 2 with a proximal end 3, a distal end 4 and a cuvette chamber 6 (not illustrated) forming the interior space of the cuvette body 2. The cuvette 1 is arranged with the proximal end 3 on a pipette tip 7 (not illustrated) and the sample 8 can be received via the distal end 4 of the cuvette 1. For this purpose, a receiving element 9 for receiving the sample 8 is attached to the distal end 4, and the receiving element 9 comprises a capillary element 10, wherein the capillary element 10 here is a capillary channel 10, and the capillary channel 10 is arranged on the receiving element 9 in such a way that the sample 8 can be received into the capillary channel 10 by capillary forces of the capillary channel 10. The cuvette 1 is characterized in that the receiving element 9 is attached to a wall 11 of the cuvette body 2 surrounding the cuvette chamber 6 in such a way that a first fluid (not illustrated) which can be introduced into the cuvette chamber 6 can be brought into contact with the sample 8 in the capillary channel 10, with the result that the sample 8 can be received into the cuvette chamber 6 by adhesion.

As shown in FIG. 1 and also 2, the receiving element 9 is arranged as an extension of at least the wall 11 of the distal end 4 of the cuvette 1. However, a plurality of extensions can also be arranged on a wall or on a plurality of walls (not illustrated).

FIG. 1 also shows that the at least one measuring surface 13 of the cuvette 1 is arranged on the cuvette body 2.

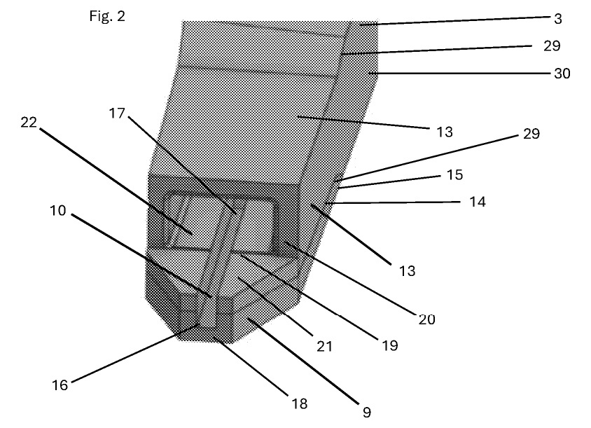

The cuvette 1 from FIG. 2 also has a tapering 29 on both sides at the distal end 4. A receiving element 9 is arranged on one of these taperings 29 in such a way that it forms a substantially planar surface 30 with the non-tapered proximal end 3 of the cuvette 1.

A circumference of an arrangement of cuvette 1 and receiving element 9, in particular a plurality of receiving elements (not shown), is thus substantially equal to the circumference of the cuvette 1 at the proximal end 3.

FIG. 2 shows a schematic illustration of the distal end 4 of the cuvette 1 according to anyone of the preceding claims, wherein the cuvette 1 has, at the distal end 4, a first connecting region 14 which is connected to the receiving element 9 by a second connecting region 15 which is attached to a proximal end 19 of the receiving element 9, with the result that the receiving element 9 is arranged in a removable manner on the cuvette 1 by the connecting regions 14, 15, wherein the first 14 and the second 15 connecting region form in particular a form-fitting plug connection.

FIG. 2 furthermore shows a cuvette 1 in which the capillary element is a capillary channel 10 and has a first opening 16 for receiving the sample 8 and a second opening 17 for dispensing the sample 8, wherein the capillary channel 10 is a capillary channel 10 which is open on a circumferential side 33, wherein the second opening 17 is the open circumferential side 33.

The capillary channel 10 in FIG. 2 extends on an inner side 21 of the receiving element 9 from a distal end 18 of the receiving element 9 via the proximal end 19 of the receiving element 9 and furthermore on an inner wall 22, adjoining the proximal end 19 of the cuvette chamber 6 (not illustrated) into the cuvette chamber 6. However, it is also conceivable for the capillary channel 10 to extend only on the inner wall 22 of the receiving element 9 as far as the cuvette chamber 6.

In this case, the receiving element 9 of the cuvette 1 is attached to the distal end 4 of the cuvette 1 in such a way that it extends over 5 - 80% of the area 20 of the distal end 4, preferably over 15 - 80% and furthermore preferably over 20 - 40% and particularly preferably over 20 - 33% of the area 20.

As shown in FIG. 1 and 2, a volume which can be received by the capillary channel 10 is predefined by the geometry of the capillary channel 10, with the result that an accurately predefinable volume can always be received by the capillary channel 10, wherein the capillary channel 10 has, in particular, a defined inner contour with a predetermined cross section and/or a corresponding length, with the result that the volume which can be received is unambiguously defined by these geometric parameters.

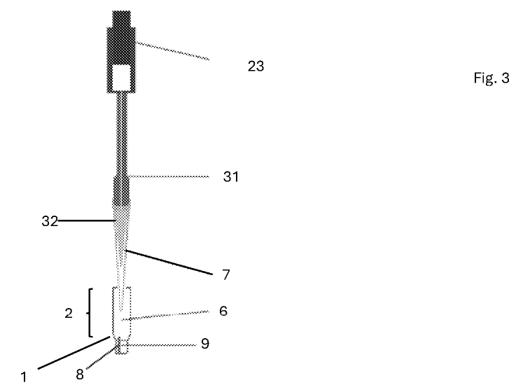

FIG. 3 shows a schematic illustration of a cuvette 2 according to the disclosure, arranged on a pipetting device 23. In this case, the cuvette 2 is arranged on an adapter 31 of the pipetting device 23 by a pipette tip 7.

The pipette tip 7 projects into the cuvette chamber 6 of the cuvette 1 which forms the interior space of the cuvette body 2. A first fluid 32, which can be brought into contact with the sample 8 located in the capillary element 10 (not illustrated) by actuation of the pipetting device 23, is introduced into the pipette tip 7.

The cuvette 1 from FIG. 3 likewise shows the receiving element 9 as an integral component of the cuvette 1.

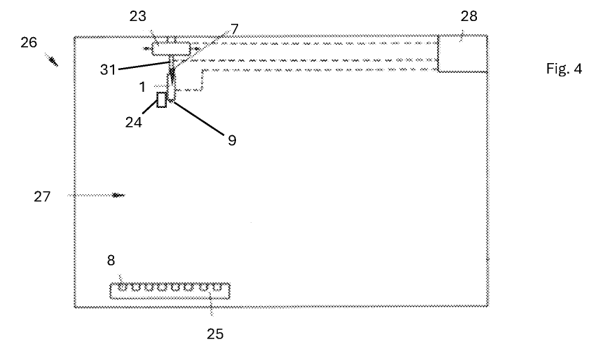

FIG. 4 shows a schematic illustration of a cuvette 1 according to the disclosure in cross section. The cross section is guided along the first opening 16 of the capillary channel 10 via the distal end 4 and the cuvette chamber 6 as far as the proximal end 3. The receiving element 9 is in this case arranged at the distal end 9.

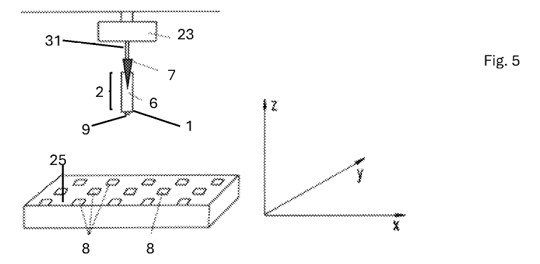

FIG. 5 shows a schematic illustration of a cuvette 1 according to the disclosure with capillary plates 10 which are arranged at the distal end 4 of the cuvette body 2 and form the capillary element of the receiving element 9.

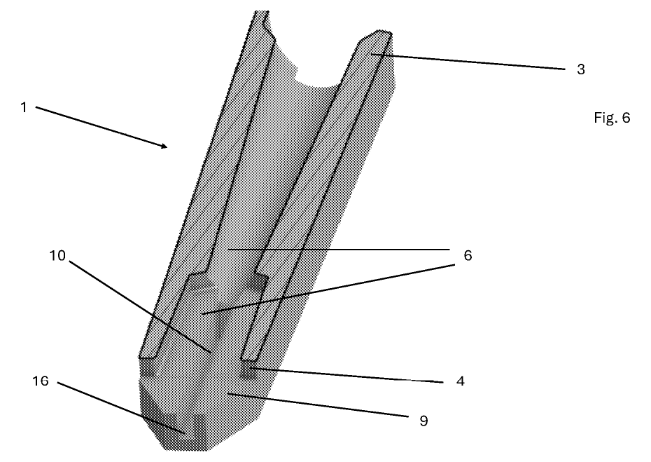

FIG. 6 shows a schematic illustration of a cuvette 1 according to the disclosure, arranged in a treatment chamber 27 of a laboratory automatic machine 26 for carrying out a method for processing a sample 8.

FIG. 6 further shows a pipetting device 23 on which the cuvette 1 is arranged. The sample 8 can be received into the capillary element 10 (not illustrated) by the receiving element 9 by introducing the receiving element 9 into the sample 8, wherein the sample 8 itself is firstly arranged in a sample container 25 in the treatment chamber 27. A control device 28 serves for introducing the receiving element 9 into the sample 8, which control device can move the pipetting device 23 through the treatment chamber 27 and can operate the functions thereof. In this case, the control device 28 can be controlled manually or can be signal-connected to a control operator (not illustrated). In particular, it can be connected in this case by cables and/or wirelessly, for example by radio, Bluetooth or W-Lan.

The sample 8 is received into the cuvette chamber 6 (not illustrated) from the capillary element 10 in this case by actuation of the pipetting device 23, with which the first fluid 32 (not illustrated) can be brought into contact with the sample 8 located in the capillary element 10, with the result that the sample 8 can be received into the cuvette chamber 6 by adhesion.

In the cuvette chamber 6, the first fluid 32 and/or the sample 8 can be mixed and also dispensed by pipetting on and off in the cuvette 1 and/or in a pipette tip 7 of the pipetting device 23.

In order to analyze the sample 8, a detection device 24 is attached in the laboratory automatic machine 26. As shown in FIG. 4, this detection device 24 can be arranged directly on the cuvette 1 or can also be arranged at different locations in the laboratory automatic machine 26, with the result that the sample 8 can be brought to the detection device 24 by the pipetting device 23.

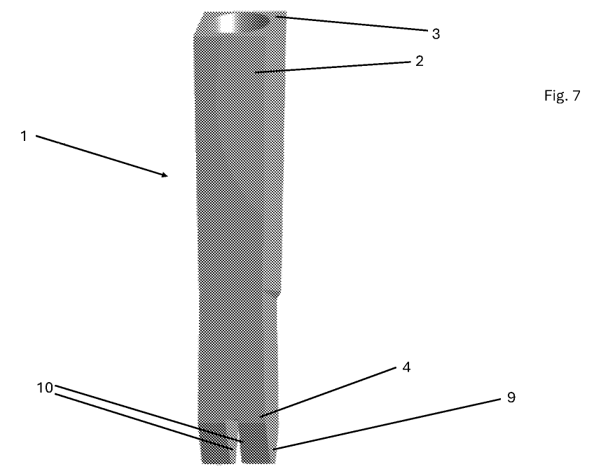

FIG. 7 shows a schematic illustration of a detail of a pipetting device 23 with a cuvette 1 according to the disclosure. The cuvette 1 is attached to the pipetting device 23 by the pipette tip 7 and the adapter 31 and projects into the cuvette chamber 6 which forms the interior space of the cuvette body 2. The cuvette 1 can thus be moved through the pipetting device 23 toward the sample container 25 with the samples 8 contained therein. The pipetting device 23 can be moved in all spatial directions (X, Y, Z), with the result that it can reach any point of the coordinate system illustrated.

As a result of the features explained above, the present disclosure allows, for the first time, samples, fluids and analysis substances to be received, processed and analyzed directly into a cuvette in small amounts with little error.

As a result, a higher accuracy of the processing is achieved and resources are saved at the same time, since smaller volumes of sample, fluid and analysis substances have to be used in order to obtain reliable data than has hitherto been the case in the state of the art.

Such a saving of resources is not only an advantage from the perspective of sustainability but also has financial advantages.

What is claimed is:

1. A cuvette for processing a sample, comprising:
a cuvette body with a proximal end, a distal end and a cuvette chamber forming an interior space of the cuvette body, the cuvette configured to be arranged with the proximal end on a pipette tip and the sample capable of being received via the distal end;
a receiving element to receive the sample is configured to be attached to the distal end, and the receiving element comprising a capillary element, the capillary element arranged on the receiving element such that the sample is capable of being received into the capillary element by capillary forces of the capillary element, and a first fluid is capable of being introduced into the cuvette chamber, the receiving element configured to be attached to a wall of the cuvette body surrounding the cuvette chamber such that the first fluid is capable of being brought into contact with the sample located in the capillary element and the sample is capable of being received into the cuvette chamber by adhesion forces of the first fluid.

2. The cuvette according to claim 1, wherein the receiving element is configured to be arranged as an extension of the wall of the distal end of the cuvette

3. The cuvette according to claim 1, comprising a measuring region arranged on the cuvette body.

4. The cuvette according to claim 1, wherein the cuvette has, at the distal end, a first connecting region configured to be connected to the receiving element by a second connecting region attached to a proximal end of the receiving element, such that the receiving element is arranged in a removable manner on the cuvette by the first and second connecting regions, and the first and the second connecting regions form a fluid-tight form-fitting plug connection.

5. The cuvette according to claim 1, wherein the capillary element extends on an inner side of the receiving element from a distal end of the receiving element via a proximal end of the receiving element and on an inner wall of the cuvette chamber adjoining the proximal end into the cuvette chamber.

6. The cuvette according to claim 5, wherein the capillary element extends only as far as the cuvette chamber.

7. The cuvette according to claim 1, wherein the receiving element is an integral component of the cuvette.

8. The cuvette according to claim 1, wherein a volume to be received by the capillary element is predefined by a geometry of the capillary element, such that an accurately predefinable volume is received by the capillary element, and the capillary element has a defined inner contour with a predetermined cross section or a corresponding length, such that the volume to be received is unambiguously defined by geometric parameters of the geometry of the capillary element.

9. The cuvette according to claim 1, wherein the capillary element is a capillary channel.

10. The cuvette according to claim 1, wherein the capillary element includes capillary plates.

11. A method for processing a sample with a cuvette according to claim 1, the method comprising
providing a pipetting device;
arranging the cuvette on the pipetting device;
receiving the sample into the capillary element by introducing the receiving element into the sample;
introducing the first fluid into the cuvette chamber by actuation of the pipetting device; and
receiving the sample into the cuvette chamber by adhesion by establishing contact between the sample located in the capillary element and the first fluid by actuation of the pipetting device.

12. The method according to claim 11, wherein the first fluid and the sample are mixed by pipetting on and off in the cuvette or in the pipette tip of the pipetting device.

13. The method according to claim 11, wherein the sample or a mixture of the first fluid and the sample are dispensed from the cuvette.

14. The method according to claim 13, wherein the sample or the fluid or the mixture of sample and the first fluid are analyzed in pr outside the cuvette chamber by a detection device.

15. The cuvette according to claim 2, comprising a measuring region arranged on the cuvette body.

16. The cuvette according to claim 2, wherein the cuvette has, at the distal end, a first connecting region configured to be connected to the receiving element by a second connecting region attached to a proximal end of the receiving element, such that the receiving element is arranged in a removable manner on the cuvette by the first and second connecting regions, and the first and the second connecting regions form a fluid-tight form-fitting plug connection.

17. The cuvette according to claim 2, wherein the capillary element extends on an inner side of the receiving element from a distal end of the receiving element via a proximal end of the receiving element and on an inner wall of the cuvette chamber adjoining the proximal end into the cuvette chamber.

18. The cuvette according to claim 1, wherein the receiving element is an integral component of the cuvette.

19. The cuvette according to claim 2, wherein a volume to be received by the capillary element is predefined by a geometry of the capillary element, such that an accurately predefinable volume is received by the capillary element, and the capillary element has a defined inner contour with a predetermined cross section or a corresponding length, such that the volume to be received is unambiguously defined by geometric parameters of the geometry of the capillary element.

20. The cuvette according to claim 2, wherein the capillary element is a capillary channel.
